(19) United States
(12) Patent Application Publication
(10) Pub. No.: US 2009/0281901 A1
(43) Pub. Date: Nov. 12, 2009

(54) Transmission system and method thereof

(75) Inventors: Cheng-Ru Lin, Taipei City (TW); An-Jye Huang, Hsinchu-City (TW); Jeng-Chun Chen, Taipei City (TW); Wei-Hao Syu, Taipei-City (TW)

Correspondence Address: BACON & THOMAS, PLLC, 625 SLATERS LANE, FOURTH FLOOR, ALEXANDRIA, VA, 22314-1176, US

(73) Assignee: ACCTON TECHNOLOGY CORPORATION, Hsinchu (TW)

(21) Appl. No.: 12/149,425

(22) Filed: May 1, 2008

(51) Int. Cl. G06Q 30/00

(52) U.S. Cl. 705/14.64; 705/14.73

(57) ABSTRACT

A transmission system comprises a server, a media receiver, and a communication device. The server is for outputting an audio advertisement data, which comprises a metadata. The media receiver is for receiving the audio advertisement data, playing the audio advertisement data, generating advertisement information based on the metadata, and outputting the advertisement information through a first communication link. The advertisement information has a markup language format. The communication device is for receiving and displaying the advertisement information.

### BACKGROUND OF THE INVENTION

1. Field of the Invention

The invention relates in general to a transmission system, and more particularly to a transmission system capable of playing an audio data, transmitting advertisement information in the audio data, and displaying the advertisement information in a communication device.

2. Description of the Related Art

As the intensity in commercial competition gets higher in every industry, the effectiveness and the efficiency of advertisement has become a key factor in the success of enterprises. Generally, the advertisement includes information promoting the product and information about the contact approach of the enterprise. As for the audio advertisement played via the internet radio, audio information promoting a product and providing contact approach information of the enterprise selling the product is included.

However, the time broadcasting the advertisement is very short due to the high cost of the advertisement time. Therefore, the potential consumer often has little time to record the information presented in the advertisement. Therefore, how to provide advertisement with friendly information approach is a subject getting more and more important for every enterprise.

### SUMMARY OF THE INVENTION

The invention is directed to a transmission system, which can stored and display the information carried in an audio data. The transmission system can effectively resolve the problem of the conventional advertisement system that the potential consumer is hard to record the information carried in an audio advertisement and advantageously provide friendly information approach to the potential consumer.

According to a first aspect of the present invention, a transmission system is provided. The transmission system comprises a server, a media receiver, and a communication device. The server is for outputting an audio advertisement data, which comprises a metadata. The media receiver is for receiving the audio advertisement data, playing the audio advertisement data, generating advertisement information based on the metadata, and outputting the advertisement information through a first communication link. The advertisement information has a markup language format. The communication device is for receiving and displaying the advertisement information.

According to a second aspect of the present invention, a transmission method is provided. The transmission method comprises: receive an audio advertisement data, which comprises a metadata; play the audio advertisement data; generate advertisement information based on the metadata, wherein the advertisement information has a markup language format; output the advertisement information to a communication device through a communication link; and receive the advertisement information and display the advertisement information.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a transmission system according to an embodiment of the invention.

FIG. 2 shows a flow chart of a transmission method according to the embodiment.

### DETAILED DESCRIPTION OF THE INVENTION

The transmission system of the embodiment plays the audio data, extract and displays the advertisement information in the audio data.

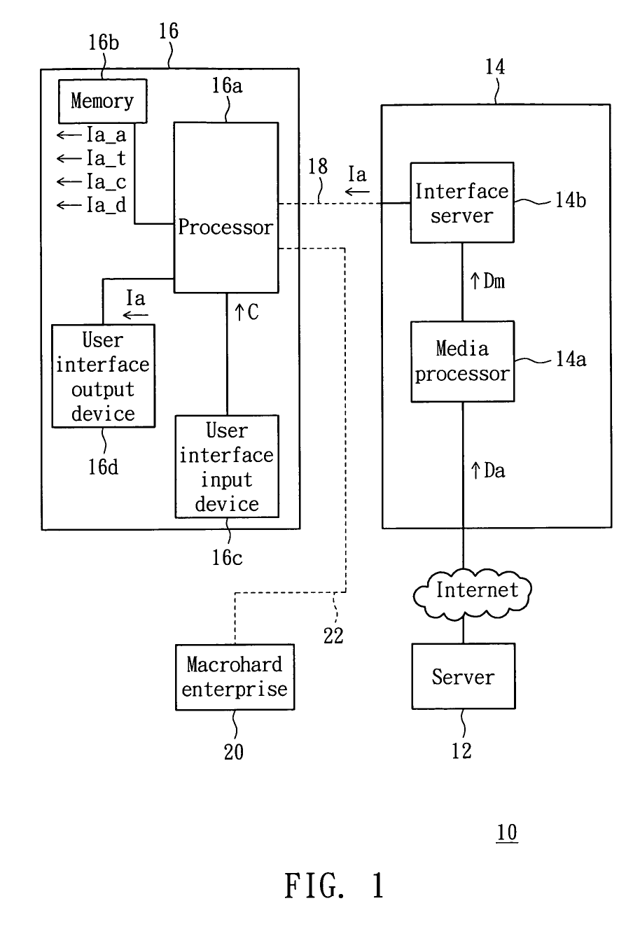

Referring to FIG. 1, a block diagram of a transmission system according to an embodiment of the invention is shown. The transmission system 10 includes a server 12, a media receiver 14, and a communication device 16. The server 12 and the media receiver 14 are connected through the internet. The media receiver 14 and the communication device 16 are connected through a communication link 18.

The sever 12 is a broadcasting server for providing an audio advertisement data Da through the internet to the media receiver 14. The audio advertisement data Da includes a metadata Dm. The metadata Dm includes information about a title, a brief summary, and a contact approach of the release source of the audio advertisement data Da. For example, the audio advertisement data Da is an audio data transmitted via internet protocol packages. The audio advertisement data Da comprises, for example, an audio program advertising for the special price of a brand new operational system, and the information about the title, the brief summary, and the contact approach respectively includes the following content: “Special price of a brand new operational system”, “Call back now to get a brand new operational system at 199$”, and “VoIP, Macrohard_Shop”. The release source of the audio advertisement data Da is, for example, a Macrohard enterprise 20 selling the operational system. The information “VoIP” represents that the type of the contact approach of the Macrohard enterprise 20 is a voice over internet protocol (VoIP) service account, which is the “macrohard_Shop”.

The media receiver 14 includes a media processor 14a and an interface server 14b. The media processor 14a receives the audio advertisement data Da, playing the audio advertisement data Da, and outputting the metadata Dm. The interface server 14b receives the metadata Dm, generates advertisement information Ia according to the metadata Dm, and broadcasts the advertisement information Ia through the communication link 18. The communication link 18 is, for example, a wireless network with user datagram protocol (UDP).

The advertisement information Ia includes the information about the title, the brief summary, and the contact approach originally included in the metadata Dm. The advertisement information Ia has a markup language format. For example, the markup language is the extensible markup language (XML). The following data structure is an example illustrating the advertisement information Ia.

```
<xml version=“1.0”?>
<Advertisement>
  <Title>Special price of a brand new operation
system</Title>
  <AudioStream>
  <URL>http://123.10.3.28:8888/ad?id=vistase1101</URL>
  </AudioStream>
  <Description>Callback now to get a brand new operation
system only at $199</Description>
  <Callback>
    <scheme>VoIP</scheme>
    <account>macrohard_shop</account>
  </Callback>
</Advertisement>
```

The information of the advertisement information Ia is included in the markup <Advertisement>. The information about the title, the brief summary, and the contact approach is respectively included in the markup <Title>, <Description>, and <Callback>. The markup <Callback> further includes markups <scheme> and <account>, which include the information “VoIP” and “macrohard_shop”. The information “VoIP” and “macrohard_shop” respectively reveals that the contact approach information is a VoIP service account and the account is the “macrohard_shop”.

The communication device 16 includes a processor 16a, a memory 16b, a user interface input device 16c, and a user interface output device 16d. The processor 16a is connected to the memory 16b, the user interface input device 16c, and the user interface output device 16d. The user interface input device 16c includes, for example, a control panel. The user interface output device 16d includes, for example, a monitor.

The processor 16a controls the memory 16b, the control panel, and the monitor. The processor 16a receives the advertisement information Ia and stores information Ia_t, Ia_d, and Ia_c, which are respectively included in the markups <title>, <description>, and <callback>. The processor 16a further informs a user that the communication device 16 receives the advertisement information Ia.

The control panel detects operation events triggered by the user and generates corresponding commands C in response to operation events to the processor 16a. For example, the user triggers a display event, and the control panel detects the display event and accordingly generates a corresponding display command. Then the display command is transmitted to the processor 16a for providing the advertisement information Ia to the monitor and controlling the monitor to display the advertisement information Ia.

The processor 16a is further used to establish a communication link 22 with the Macrohard enterprise 20 according to the command C. For example, when the user decides to contact the Macrohard enterprise 20 for further detail information, the user triggers a corresponding contact event and the control panel generates a corresponding contact command to the processor 16a in response. The processor 16a obtains the information Ia_c, which includes the information “VoIP” and “macrohard_shop”. Then the processor 16a establishes the communication link 22 according to the command C and based on the information “VoIP” and “macrohard_shop”. Therefore, the user can contact with the Macrohard enterprise 20 directly through the VoIP service. The communication link 22 is, for example, a network through the internet. Thus, the user can contact with the Macrohard enterprise 20 via the VoIP service.

The transmission system 10 includes the media receiver 14 and the communication device 16. The media receiver 14 generates the advertisement information Ia according to the audio advertisement data Da. The communication device 16 receives, stores, and displays the advertisement information Ia. Thus, the user can effectively obtain the advertisement information Ia delivered by the audio advertisement data Da even the broadcasting time of the advertisement is short.

The communication device 16 is, for example, a Wi-Fi enabled device. In some cases, the communication device 16 can be a personal digital assistants (PDA) or a voice over internet protocol (VoIP) device (such as Skype phone). The communication device 16 establishes the communication link 22 with the release source of the audio advertisement data Da. Thus, the transmission system 10 can provide friendly contact approach to the Macrohard enterprise 20 for the user.

The advertisement information Ia further includes information included in the markup <audiostream>Ia_a, which is the location information of the audio advertisement data Da on the web. For example, the information Ia_a is described by a uniform resource locator (URL), which is included in the markup <URL>. The processor 16a further stores the information Ia_a in the memory 16b. The processor 16a is further used to access data on the web, such as the audio advertisement data Da according to the information Ia_a. Thus, the processor 16a is capable of accessing the audio advertisement data Da according to an access command generated by the control panel. The control panel generates the access command according to an access event triggered by the user. Therefore, the processor 16a is further capable of replaying the audio advertisement data Da according to the access command and the information Ia_a.

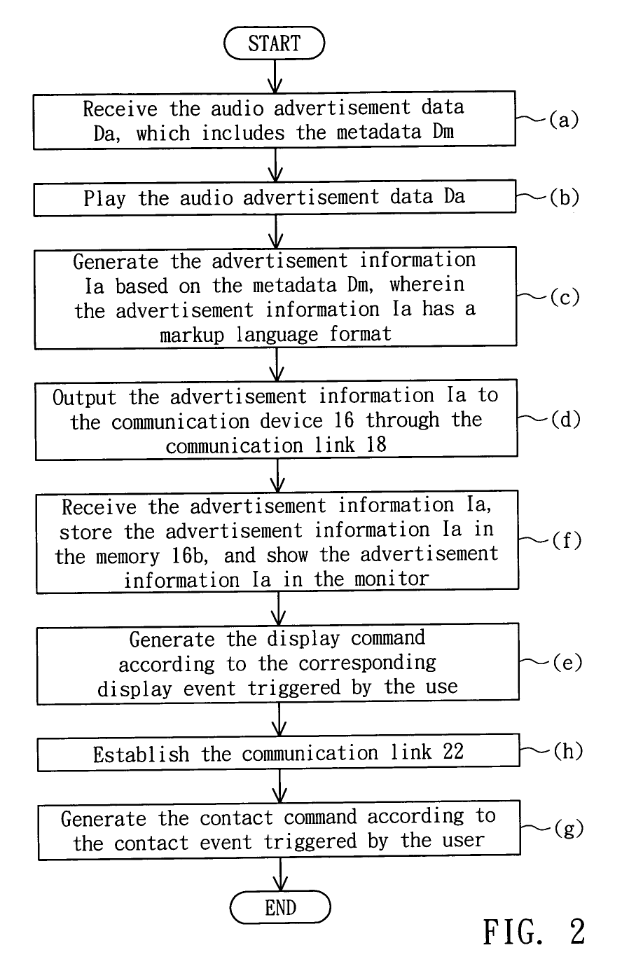

Referring to FIG. 2, a flow chart of a transmission method according to the embodiment is shown. First, in step (a), the media receiver 14 receives the audio advertisement data Da, which includes the metadata Dm. Then in step (b), the media processor 14a plays the audio advertisement data Da. Next in step (c), the interface server 14b generates the advertisement information Ia based on the metadata Dm. The advertisement information Ia has a markup language format, which is, for example, the XML. Then in step (d), the interface server 14b outputs the advertisement information Ia to the communication device 16 through the communication link 18, which is a nework with UDP. After that in step (e), the processor 16a receives the advertisement information Ia, stores the advertisement information Ia in the memory 16b, and displays the advertisement information Ia in the monitor.

Before the step (e), the transmission method of the embodiment further includes step (f), the control panel generates the display command according to the corresponding display event triggered by the user. Then the transmission method performs the step (e) according to the display command.

After the step (e), the transmission method of the embodiment further includes step (g), the communication device 16 establishes the communication link 22. Then the user can contact with the Macrohard enterprise 20 through the communication link 22. Before the step (g), the transmission method of the embodiment further includes steps (h), the control panel generates the contact command in response to the contact event triggered by the user. Then transmission method performs the step (f) according to the contact command.

The transmission system of the embodiment includes a media receiver and a communication device for respectively generating advertisement information according to an audio advertisement data and storing, and displaying the advertisement information. Therefore, when the audio advertisement is broadcasted, a user can easily obtain the displaying advertisement information.

The communication device can provide a communication link with the release source of the audio advertisement data according to the advertisement information. Therefore, the transmission system can further provide friendly access approach to the potential customer to contact with the release source of the audio advertisement data. Therefore, the effectiveness and the efficiency of the advertisement is achieved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transmission method, comprising:
(a) receiving an audio advertisement data, which comprises a metadata;
(b) playing the audio advertisement data;
(c) generating a advertisement information based on the metadata, wherein the advertisement information has a markup language format; and
(d) outputting the advertisement information to a communication device through a communication link.

2. The transmission method according to claim 1, further comprising:
(e) obtaining the advertisement information and displaying the advertisement information.

3. The transmission method according to claim 2, further comprising:
(f) generating a command in response to an operation event;
wherein the step (e) are operated according to the command.

4. The transmission method according to claim 1, further comprising:
(g) establishing a communication link with the release source of the audio advertisement according to the advertisement information.

5. The transmission method according to claim 4, further comprising:
(h) generating a command in response to an operation event;
wherein, the step (g) are operated according to the command.

6. A computer readable medium, having computer-executable instructions for performing a method, wherein the instructions comprise:
(a) receiving an audio advertisement data, which comprises a metadata;
(b) playing the audio advertisement data;
(c) generating a advertisement information based on the metadata, wherein the advertisement information has a markup language format; and
(d) outputting the advertisement information to a communication device through a communication link.
